(19) United States
(12) Patent Application Publication
(10) Pub. No.: US 2026/0066408 A1
(43) Pub. Date: Mar. 5, 2026

(54) CAP ASSEMBLY, SECONDARY BATTERY INCLUDING THE SAME, AND CAP ASSEMBLY MANUFACTURING METHOD

(71) Applicant: SAMSUNG SDI CO., LTD., Yongin-si (KR)

(72) Inventor: Dae-Sup KIM, Yongin-si (KR)

(21) Appl. No.: 19/021,679

(22) Filed: Jan. 15, 2025

(30) Foreign Application Priority Data
Sep. 4, 2024 (KR) 10-2024-0120143

(51) Int. Cl. H01M 50/152; H01M 50/171; H01M 50/188; H01M 50/193

(52) U.S. Cl. CPC H01M 50/152; H01M 50/171; H01M 50/188; H01M 50/193

(57) ABSTRACT

A cap assembly includes a base portion having a through-hole, a protrusion joined to the base portion, the protrusion extending downward from a lower end of the through-hole, an electrode terminal at least partially inserted into the protrusion, the electrode terminal sealing the through-hole, and a sealing member between the protrusion and the electrode terminal.

### CROSS-REFERENCE TO RELATED APPLICATION

This application claims priority under 35 U.S.C § 119 to Korean Patent Application No. 10-2024-0120143, filed in the Korean Intellectual Property Office on Sep. 4, 2024, the entire contents of which are hereby incorporated by reference.

### BACKGROUND

### 1. Field

Embodiments relate to a cap assembly, a secondary battery including the cap assembly, and a method for manufacturing the cap assembly.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

A typical coin-type battery or a button-type battery includes a case that accommodates an electrode assembly having a jelly roll shape and a cap assembly that is coupled to an upper part of the case to seal the electrode assembly from the outside.

The above information disclosed in this Background section is for enhancement of understanding of the background of the present disclosure, and therefore, it may contain information that does not constitute related (or prior) art.

### SUMMARY

Embodiments include a cap assembly, including a base portion having a through-hole, a protrusion joined to the base portion, the protrusion extending downward from a lower end of the through-hole, an electrode terminal at least partially inserted into the protrusion, the electrode terminal sealing the through-hole, and a sealing member between the protrusion and the electrode terminal.

A length of the protrusion may be less than a length of the electrode terminal and a length of the sealing member.

The protrusion may include at least one locking groove recessed outwardly from an inner circumferential surface of the protrusion, and the electrode terminal may include at least one locking protrusion protruding from an outer circumferential surface of the electrode terminal in correspondence with a shape of the locking groove.

The at least one locking protrusion is press-fitted into the at least one locking groove with the sealing member therebetween.

The sealing member may be a polymer-based adhesive including at least one of maleic anhydride grafted polypropylene and polypropylene.

The sealing member may extend outward from the through-hole to cover an upper surface of the base portion.

The protrusion may include a threaded groove recessed outwardly from an inner circumferential surface of the protrusion, the threaded groove extending along a longitudinal direction of the protrusion, and the electrode terminal includes a thread protruding outwardly from an outer circumferential surface of the electrode terminal, the electrode terminal extending along a longitudinal direction thereof, the thread having a shape corresponding to a shape of the threaded groove.

The thread may be engaged with the threaded groove, and the sealing member may be between the electrode terminal and the protrusion.

The electrode terminal may further include a stepped portion at an upper end thereof.

The protrusion may include at least one locking groove recessed outwardly from an inner circumferential surface of the protrusion, and the electrode terminal may include at least one locking protrusion protruding from an outer circumferential surface of the electrode terminal in correspondence with a shape of the locking groove.

The protrusion may include a threaded groove recessed outwardly from an inner circumferential surface of the protrusion, the protrusion extending along a longitudinal direction thereof, and the electrode terminal may include a thread protruding outwardly from an outer circumferential surface of the electrode terminal, the electrode terminal extending along a longitudinal direction thereof, the thread having a shape corresponding to a shape of the threaded groove.

Embodiments include a secondary battery, including an electrode assembly including a first electrode, a separator, and a second electrode, a case having one open side, the case accommodating the electrode assembly through the open side, and a cap assembly coupled to the open side of the case, wherein the cap assembly includes a base portion having a through-hole, a protrusion joined to the base portion, the protrusion extending downward from a lower end of the through-hole, an electrode terminal at least partially inserted into the protrusion, the electrode terminal sealing the through-hole, and a sealing member between the protrusion and the electrode terminal.

Embodiments include a method for manufacturing a cap assembly, the method including forming a through-hole in a base portion, joining a protrusion extending downward from a lower end of the through-hole, to the base portion, disposing a sealing member on an inner circumferential surface of the protrusion and an upper surface of the base portion, and sealing the through-hole by inserting an electrode terminal at least partially into the protrusion in which the sealing member is surrounded by the protrusion.

The method may further include pressing an outer circumferential surface of the protrusion after sealing the through-hole.

In joining the protrusion to the base portion, the protrusion may have a length less than a length of the electrode terminal and a length of the sealing member.

In sealing the through-hole, the electrode terminal may be secured to the protrusion by pressing a locking protrusion at the electrode terminal into a locking groove at the protrusion, the sealing member positioned between the electrode terminal and the protrusion.

Sealing the through-hole may include engaging a thread at the electrode terminal with a threaded groove at the protrusion with the sealing member positioned between the electrode terminal and the protrusion.

Disposing the sealing member may include forming the sealing member of a polymer-based adhesive including at least one of maleic anhydride grafted polypropylene and polypropylene.

Sealing the through-hole may include press-fitting the electrode terminal into the protrusion while compressing the sealing member.

Sealing the through-hole may further include forming a stepped portion in the electrode terminal at an upper end thereof.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

Features will become apparent to those of skill in the art by describing in detail exemplary embodiments with reference to the attached drawings, in which:

FIG. 1 illustrates a cross-sectional view of a secondary battery according to one or more embodiments of the present disclosure;

FIG. 2 illustrates a cross-sectional view of a cap assembly according to one or more embodiments of the present disclosure;

FIG. 3 illustrates a top view of a cap assembly according to one or more embodiments of the present disclosure;

FIG. 4 illustrates a cross-sectional view of a cap assembly according to one or more embodiments of the present disclosure;

FIG. 5 illustrates a cross-sectional view of a cap assembly according to one or more embodiments of the present disclosure;

FIG. 6 illustrates a cross-sectional view of a cap assembly to which an electrode terminal is applied according to one or more embodiments of the present disclosure;

FIG. 7 illustrates a cross-sectional view of a cap assembly to which an electrode terminal is applied according to one or more embodiments of the present disclosure;

FIG. 8 illustrates a cross-sectional view of a cap assembly to which an electrode terminal is applied according to one or more embodiments of the present disclosure;

FIG. 9 illustrates a plan view of a cap assembly to which an electrode terminal is applied according to one or more embodiments of the present disclosure;

FIG. 10 illustrates a flowchart of a method for manufacturing a cap assembly according to one or more embodiments of the present disclosure;

FIG. 11 illustrates a state prior to an insertion of an electrode terminal into a protrusion in a method for manufacturing a cap assembly according to one or more embodiments of the present disclosure; and

FIG. 12 illustrates a process of applying pressure to a protrusion into which an electrode terminal is inserted in a method for manufacturing a cap assembly according to one or more embodiments of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her embodiments in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

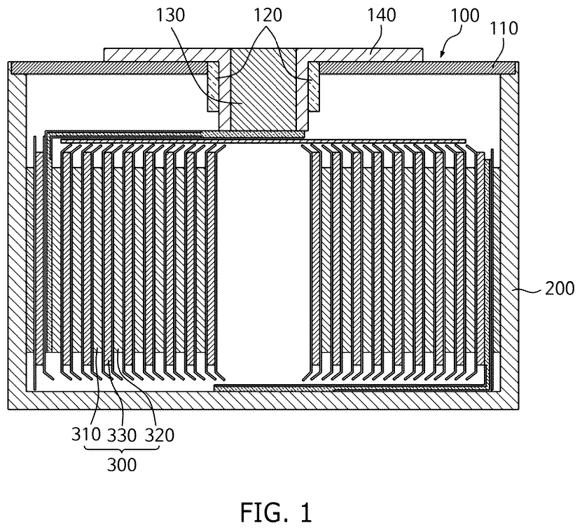

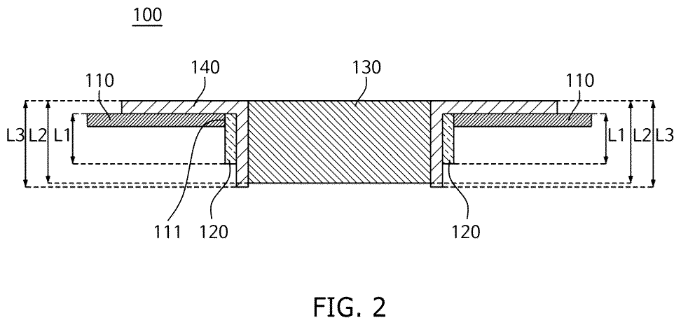

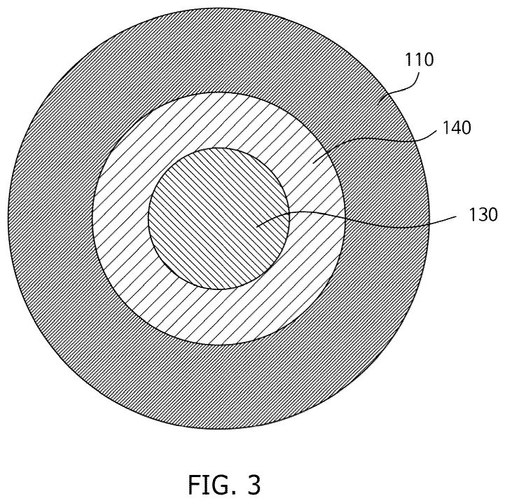

FIG. 1 illustrates a cross-sectional view of a secondary battery according to one or more embodiments of the present disclosure, FIG. 2 illustrates a cross-sectional view of a cap assembly according to one or more embodiments of the present disclosure, and FIG. 3 illustrates a top view of a cap assembly according to one or more embodiments of the present disclosure.

FIG. 1 illustrates a cross-sectional view showing a structure in which a secondary battery having a substantially cylindrical shape is cut in a height direction along a line passing through the center of the secondary battery. As shown in FIG. 1, the secondary battery may include a cap assembly 100, a case 200, and an electrode assembly 300.

In one or more embodiments, the secondary battery may be a coin cell or a button cell, but may also be a cylindrical or pin-shaped battery.

Coin-type batteries or button-type batteries are batteries in the shape of thin coins or buttons, and may refer to batteries having a height to diameter (height/diameter) ratio of 1 or less, but other ratios are possible. Coin-type batteries or button-type batteries are mainly cylindrical, so their horizontal cross-sections are circular, but shapes having an oval or polygonal horizontal cross-section may also be included. In this case, the diameter may refer to the maximum distance based on the horizontal direction of the battery, and the height may refer to the maximum distance based on the vertical direction of the battery (the distance from the flat bottom surface to the flat top surface).

The cap assembly 100 may include a base portion 110, a protrusion 120, an electrode terminal 130, and a sealing member 140. Here, the base portion 110 may cover one open side of the case 200. In one or more embodiments, the base portion 110 may be joined to a side surface of the case 200, which corresponds to a side surface of the open side (opening) of the case 200. The base portion 110 may have a through-hole 111. In one or more embodiments, the through-hole 111 may be formed at a center of the base portion 110.

In one or more embodiments, the protrusion 120 may be jointed to the base portion 110. The protrusion 120 may be formed to extend downward from a lower end of the through-hole 111 (in the orientation shown). For example, the protrusion 120 may be formed in a cylindrical shape and joined to the base portion 110 while extending downward from the lower end of the through-hole 111 of the base portion 110.

The electrode terminal 130 may be inserted into the protrusion 120. In one or more embodiments, at least a portion of the electrode terminal 130 may be inserted into the protrusion 120. The electrode terminal 130 may seal the through-hole 111 as the electrode terminal 130 is inserted into the protrusion 120. The electrode terminal 130 may be secured by being inserted into the protrusion 120. In one or more embodiments, the electrode terminal 130 may be electrically connected by contacting a positive electrode tab within the case 200.

In one or more embodiments, the sealing member 140 may be disposed between the protrusion 120 and the electrode terminal 130. The sealing member 140 may be a polymer-based adhesive including at least one of maleic anhydride grafted polypropylene (MAPP) and polypropylene (PP).

For example, the sealing member 140 may be formed with a coating solution containing an insulating material applied thereon. In another example, a portion of the sealing member 140 may be formed with an insulating tape adhered thereon while the remaining portion of the sealing member 140 may be formed with a coating solution containing an insulating material applied thereon.

For example, the sealing member 140 may be disposed between the protrusion 120 and the electrode terminal 130. In one or more embodiments, the sealing member 140 may have adhesive properties to bond the electrode terminal 130 and the protrusion 120. The sealing member 140 may include an adhesive material to bond the electrode terminal 130 and the protrusion 120. In another example, the sealing member 140 may have adhesive layers disposed on both sides thereof, allowing the sealing member 140 to bond the electrode terminal 130 and the protrusion 120. The sealing member 140 may be formed of an insulating material to electrically insulate the electrode terminal 130 from the protrusion 120.

In one or more embodiments, the sealing member 140 may extend outward from the through-hole 111 to cover an upper surface of the base portion 110. The sealing member 140 may be formed of an insulating material, electrically insulating the electrode terminal 130 from the base portion 110. For example, as shown in FIG. 3, the sealing member 140 may have a disc shape and extend outward from the through-hole 111, covering a portion of the upper surface of the base portion 110.

Referring to FIG. 2, the protrusion 120 may be formed to have a length L1 that is smaller than a length L2 of the electrode terminal 130 and a length L3 of the sealing member 140. The electrode terminal 130 is electrically connected by contacting the positive electrode tab within the case 200, and in order to avoid interference in the connection between the positive electrode tab and the electrode terminal 130, the length L1 of the protrusion 120 may be formed to be smaller than the length L2 of the electrode terminal 130. Further, the length L1 of the protrusion 120 may be formed to be smaller than the length L3 of the sealing member 140, such that the sealing member 140 may electrically insulate the electrode terminal 130 from the protrusion 120.

The case 200 may accommodate the electrode assembly 300 and the electrolyte, and may form an overall outer appearance of the secondary battery together with the cap assembly 100. The case 200 may include a substantially cylindrical sidewall portion and a bottom portion connected to one side of the sidewall portion. However, the case 200 may be formed into various shapes, such as a circular shape, a pouch shape, or the like. Further, the case 200 may be formed of a metal, such as aluminum, an aluminum alloy, a nickel-plated steel, or the like. For example, the case 200 may be formed of a laminated film or a plastic that forms the pouch.

The case 200 may accommodate the electrode assembly 300. The case 200 may have one open side (opening), through which the electrode assembly 300 may be inserted. The open side of the case 200 may be sealed by the cap assembly 100. The cap assembly 100 may be joined to the open side of the case 200. The open side of the case 200 may be sealed by the cap assembly 100 through welding.

The electrode assembly 300 may include a first electrode 310, a second electrode 320, and a separator 330 therebetween. Specifically, the electrode assembly 300 may be configured by winding the first electrode 310 and the second electrode 320 together with the separator 330 interposed between the first electrode 310 and the second electrode 320. The electrode assembly 300 may be wound to form a winding core, and may include a through-hole in the winding core.

The first electrode 310 may include a first substrate and a first active material layer positioned on the first substrate. A first electrode tab may extend outward from a first uncoated portion of the first substrate where the first active material layer is not positioned, and the first electrode tab may be electrically connected to the electrode terminal 130 of the cap assembly 100.

The second electrode 320 may include a second substrate and a second active material layer positioned on the second substrate. A second electrode tab may extend outward from a second uncoated portion of the second substrate where the second active material layer is not positioned, and the second electrode tab may be electrically connected to the case 200. The first electrode tab and the second electrode tab may extend in opposite directions. The first electrode 310 may serve as a positive electrode. In this case, the first substrate may be a positive electrode substrate.

The positive electrode active material may include a compound (lithiated intercalation compound) that is capable of intercalating and deintercalating lithium. Specifically, at least one of a composite oxide of lithium and a metal selected from cobalt, manganese, nickel, and combinations thereof may be used.

The composite oxide may be a lithium transition metal composite oxide. Specific examples of the composite oxide may include lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}Co_{b}X_{c}O_{2-α}D_{α} (0.90≤a≤1.8, 0≤b≤0.5, 0≤c≤0.5, and 0<α<2); LiₐNi_{1-b-c}Mn_{b}X_{c}O_{2-α}D_{α} (0.90≤a≤1.8, 0≤b≤0.5, 0≤c≤0.5, and 0<α<2); LiₐNi_{b}Co_{c}L¹_{d}GₑO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃ (0≤f≤2); or LiₐFePO₄ (0.90≤a≤1.8).

In the above Chemical Formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof, G is Al, Cr, Mn, Fe, Mg, La, Ce, Sr, V, or a combination thereof; and L¹ is Mn, Al, or a combination thereof.

The positive electrode active material may be, for example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity and can be applied to a high-capacity, high-density rechargeable lithium battery.

The second electrode 320 may serve as the negative electrode. In this case, the second substrate may be a negative substrate.

The negative electrode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example. crystalline carbon, amorphous carbon or a combination thereof. The crystalline carbon may be graphite such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOx (0<x<2), a Si-Q alloy (where Q is selected from an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnO₂, a Sn-based alloy, or a combination thereof.

The silicon-carbon composite may be a composite of silicon and amorphous carbon. According to an embodiment, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

The separator may include polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator may include a porous substrate and a coating layer including an organic material, an inorganic material, or a combination thereof on one or both surfaces of the porous substrate.

The porous substrate may be a polymer film formed of any one selected polymer polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be mixed in one coating layer, or a coating layer including an organic material and a coating layer including an inorganic material may be stacked.

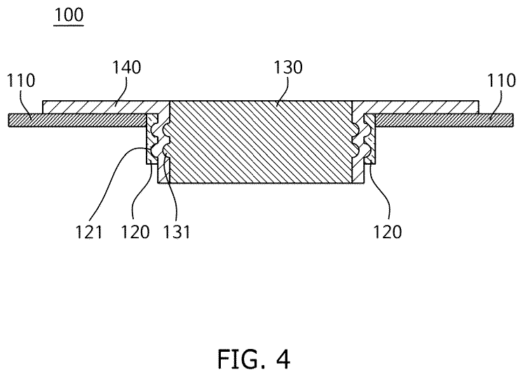

FIG. 4 illustrates a cross-sectional view of a cap assembly according to one or more embodiments of the present disclosure. The description of configurations corresponding to the above-described configurations will be omitted, but the description will be focus on configurations different from the above-described configurations.

Referring to FIG. 4, the sealing member 140 may be disposed on at least a portion of the base portion 110. In this case, an outer periphery of the sealing member 140 may be spaced apart from an outer periphery of the base portion 110 by a predetermined distance. For example, an outer diameter of the sealing member 140 may be smaller than an outer diameter of the base portion 110.

The sealing member 140 may be further disposed on an inner surface of the protrusion 120. For example, the sealing member 140 may by surround by the inner surface of the protrusion 120. The sealing member 140 may be disposed between the electrode terminal 130 and the protrusion 120 to prevent a short circuit between the electrode terminal 130 and the protrusion 120. The sealing member 140 may seal a gap between the electrode terminal 130 and the protrusion 120.

The protrusion 120 may include at least one locking groove 121, which is recessed outwardly from an inner circumferential surface thereof. Each locking groove 121 may be formed to be recessed outwardly in a radial direction of the protrusion 120. For example, as shown in FIG. 4, two locking grooves 121 may be formed to be spaced apart at a predetermined interval along a longitudinal direction of the protrusion 120.

The electrode terminal 130 may include at least one locking protrusion 131, which protrudes from an outer circumferential surface thereof in correspondence with the shape of the locking groove 121. Each locking protrusion 131 may be formed to protrude outwardly in a radial direction from the electrode terminal 130. For example, as shown in FIG. 4, two locking protrusions 131 may be formed to be spaced apart at a predetermined interval along a longitudinal direction of the electrode terminal 130.

In the cap assembly 100, according to one or more embodiments, the locking protrusion 131 of the electrode terminal 130 may be press-fitted into the locking groove 121 with the sealing member 140 positioned therebetween, thereby securing the electrode terminal 130 to the protrusion 120. Upon insertion of the electrode terminal 130 into the protrusion 120, the locking protrusion 131 may be press-fitted into the locking groove 121, and the sealing member 140 may be compressed. Because the locking groove 121 has the shape corresponding to the shape of the locking protrusion 131 (e.g., the two shapes are complimentary and mate together), the electrode terminal 130 may be more firmly fastened to the protrusion 120.

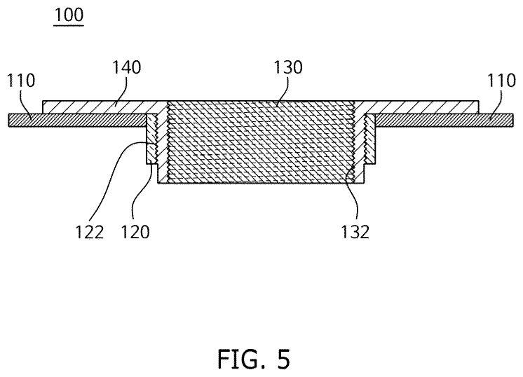

FIG. 5 illustrates a cross-sectional view of a cap assembly according to one or more embodiments of the present disclosure. The description of configurations corresponding to the above-described configurations will be omitted, but the description will focus on configurations different from the above-described configurations.

Referring to FIG. 5, the protrusion 120 may include a threaded groove 122 recessed outwardly from the inner circumferential surface thereof and formed to extend along the longitudinal direction of the protrusion 120. The threaded groove 122 may be formed to be recessed outwardly in the radial direction of the protrusion 120. For example, as shown in FIG. 5, the threaded groove 122 may extend along the longitudinal direction of the protrusion 120.

The electrode terminal 130 may include a thread 132 protruding outwardly from the outer circumferential surface thereof in correspondence with the threaded groove 122 and formed to extend along the longitudinal direction of the electrode terminal 130. The thread 132 may be formed to protrude outwardly in the radial direction of the electrode terminal 130. For example, as shown in FIG. 5, the thread 132 may be formed to extend along the longitudinal direction of the electrode terminal 130.

In the cap assembly 100, according to one or more embodiments, the thread 132 of the electrode terminal 130 may be screwed with the threaded groove 122 with the sealing member 140 positioned therebetween, thereby securing the electrode terminal 130 to the protrusion 120. As the electrode terminal 130 rotates and is inserted into the protrusion 120, the thread 132 may be press-fitted into the threaded groove 122, and the sealing member 140 may be compressed. Because the threaded groove 122 has the shape corresponding to the shape of the thread 132, the electrode terminal 130 may be more firmly fastened to the protrusion 120.

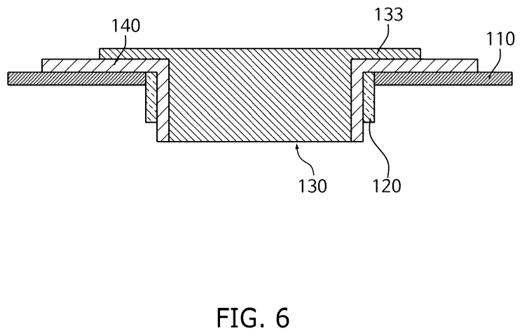

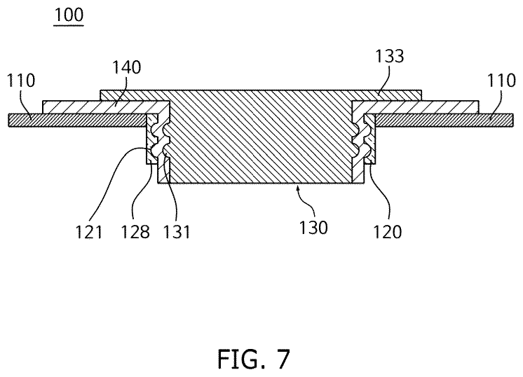

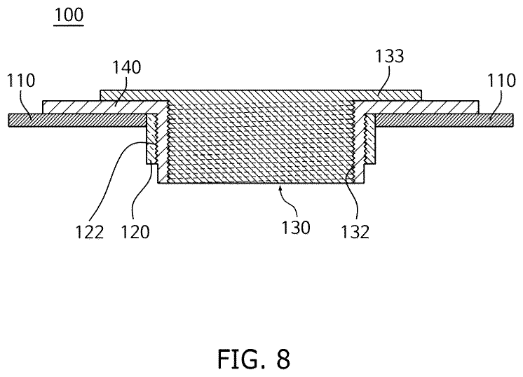

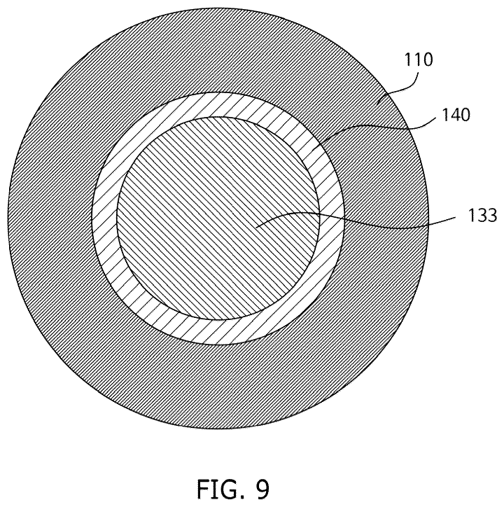

FIGS. 6 to 9 illustrate cross-sectional views and plan views of a cap assembly to which an electrode terminal is applied according to one or more embodiments of the present disclosure. The description of configurations corresponding to the above-described configurations will be omitted, but the description will be focus on configurations different from the above-described configurations.

Referring to FIGS. 6 to 9, the electrode terminal 130 may further include a stepped portion 133 formed an upper end thereof. For example, the stepped portion 133 may be formed in a disc shape. In one or more embodiments, an outer diameter of the stepped portion 133 may be smaller than that of the sealing member 140. This configuration allows the sealing member 140 to electrically insulate the electrode terminal 130 from the base portion 110.

In one or more embodiments, the protrusion 120 may be joined to the base portion 110. The protrusion 120 may be formed to extend downward from the lower end of the through-hole 111 (in the orientation shown). For example, the protrusion 120 may be formed in a cylindrical shape and joined to the base portion 110 while extending downward from the lower end of the through-hole 111 of the base portion 110.

The electrode terminal 130 may be inserted into the protrusion 120. In one or more embodiments, the electrode terminal 130 may be at least partially inserted into the protrusion 120 with the stepped portion 133 being exposed to the outside. In one or more embodiments, the electrode terminal 130 may be electrically connected by contacting the positive electrode tab within the case 200, while the stepped portion 133 remains exposed to the outside for connection with an external terminal.

In one or more embodiments, the sealing member 140 may be disposed between the protrusion 120 and the electrode terminal 130. Further, the sealing member 140 may be disposed between the stepped portion 133 and the base portion 110. The sealing member 140 may be a polymer-based adhesive including at least one of maleic anhydride grafted polypropylene (MAPP) and polypropylene (PP).

For example, the sealing member 140 may have adhesive properties to bond the stepped portion 133 and the base portion 110. The sealing member 140 may include an adhesive material to bond the stepped portion 133 and the base portion 110. Furthermore, the sealing member 140 may be formed of an insulating material to electrically insulate the stepped portion 133 from the base portion 110.

In one or more embodiments, the protrusion 120 may include at least one locking groove 121, which is recessed outwardly from the inner circumferential surface thereof. Each locking groove 121 may be formed to be recessed outwardly in the radial direction of the protrusion 120. The electrode terminal 130 may include at least one locking protrusion 131, which protrudes from the outer circumferential surface thereof in correspondence with the shape of the locking groove 121. The locking protrusion 131 may be formed to protrude outwardly in the radial direction of the electrode terminal 130. The locking protrusion 131 of the electrode terminal 130 may be press-fitted into the locking groove 121 with the sealing member 140 positioned therebetween, securing the electrode terminal 130 to the protrusion 120. The stepped portion 133 may be exposed to the outside in a state where the electrode terminal 130 is inserted into the protrusion 120.

In one or more embodiments, the protrusion 120 may include a threaded groove 122 recessed outwardly from the inner circumferential surface thereof and formed to extend along the longitudinal direction of the protrusion 120. The threaded groove 122 may be formed to be recessed outwardly in the radial direction of the protrusion 120. The electrode terminal 130 may include a thread 132 protruding from the outer circumferential surface thereof in correspondence with the threaded groove 122 and formed to extend along the longitudinal direction of the electrode terminal 130. The thread 132 may be formed to protrude outwardly in the radial direction of the electrode terminal 130. The stepped portion 133 may be exposed to the outside in a state where the electrode terminal 130 is screwed into the protrusion 120.

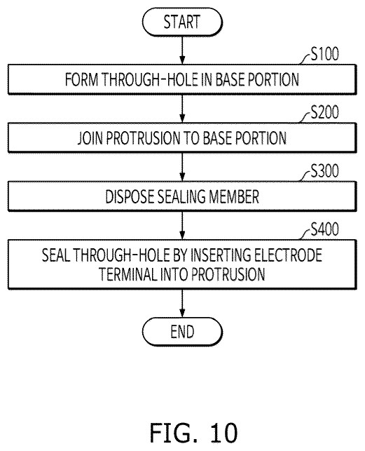

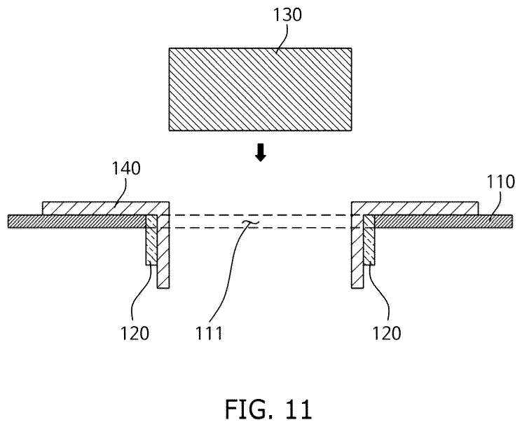

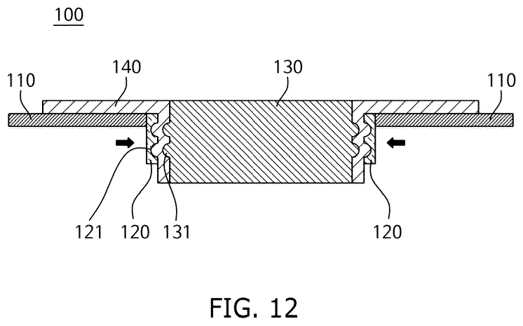

FIG. 10 illustrates a flowchart of a method for manufacturing a cap assembly according to one or more embodiments of the present disclosure, FIG. 11 illustrates a state prior to an insertion of an electrode terminal into a protrusion in a method for manufacturing a cap assembly according to one or more embodiments of the present disclosure, and FIG. 12 illustrates a process of applying pressure to a protrusion into which an electrode terminal is inserted in a method for manufacturing a cap assembly according to one or more embodiments of the present disclosure.

In one or more embodiments, a method for manufacturing a cap assembly may include a step of forming a through-hole in the base portion (step S100), a step of joining the protrusion to the base portion (step S200), a step of disposing the sealing member (step S300), and a step of sealing the through-hole by inserting the electrode terminal into the protrusion (step S400).

In the step S100 of forming the through-hole in the base portion, the through-hole 111 may be formed by drilling a circular hole at the center of the base portion 110. After the step S100 of forming the through-hole, the protrusion 120 may be joined to the base portion 110. In the step S200 of joining the protrusion to the base portion, the protrusion 120 may be formed to extend from the through-hole 111 of the base portion 110.

The step S200 of joining the protrusion to the base portion may include a step of joining the protrusion 120 extending downwardly from a lower end of the through-hole 111 to the base portion 110. In one or more embodiments, in the step S200 of joining the protrusion to the base portion, the protrusion may be formed to have a length that is smaller than a length of the electrode terminal and a length of the sealing member. In one or more embodiments, in the step S100 of forming the through-hole in the base portion, the through-hole may be formed simultaneously with the protrusion. For example, by utilizing various pressing processes, such as deep drawing, the step S100 of forming the through-hole in the base portion and the step S200 of joining the protrusion to the base portion may be performed simultaneously.

In the step S300 of disposing the sealing member, the sealing member 140 may be disposed on the inner circumferential surface of the protrusion 120 and the upper surface of the base portion 110. In the step S300 of disposing the sealing member 140, the sealing member 140 may be a polymer-based adhesive including at least one of maleic anhydride grafted polypropylene (MAPP) and polypropylene (PP). Subsequently, the step S400 of sealing the through-hole may be performed.

In the step S400 of sealing the through-hole, the electrode terminal 130 may be secured to the protrusion by pressing the locking protrusion formed at the electrode terminal 130 into the locking groove formed at the protrusion with the sealing member 140 positioned between the electrode terminal 130 and the protrusion.

In one or more embodiments, in the step S400 of sealing the through-hole, the electrode terminal 130 may be secured to the protrusion by engaging the thread formed at the electrode terminal with the threaded groove formed at the protrusion 120 with the sealing member 140 positioned between the electrode terminal 130 and the protrusion 120.

In one or more embodiments, in the step S400 of sealing the through hole, the electrode terminal may be press-fitted into the protrusion while compressing the sealing member. Here, the electrode terminal may further include the stepped portion formed at the upper end thereof.

In one or more embodiments, after the step S400 of sealing the through-hole, the method may further include a step of pressing the outer circumferential surface of the protrusion. As illustrated in FIG. 12, the outer circumferential surface of the protrusion 120 may be pressed in a state where the electrode terminal 130 fitted into the protrusion 120 and compresses the sealing member 140. For example, the outer circumferential surface of the protrusion 120 may be pressed using a thermal compression method. At this time, the bonding force between the protrusion and the electrode terminal may be further enhanced due to the adhesive properties of the sealing member (140).

In the embodiment shown in FIG. 12 of the cap assembly 100, the electrode terminal 130 may be secured to the protrusion 120 as the locking protrusion 131 of the electrode terminal 130 is press-fitted into the locking groove 121 with the sealing member 140 positioned therebetween. Upon insertion of the electrode terminal 130 into the protrusion 120, the locking protrusion 131 may be press-fitted into the locking groove 121, and the sealing member 140 may be compressed. The locking groove 121 has the shape corresponding to the shape of the locking protrusion 131, allowing the electrode terminal 130 to be more firmly fastened to the protrusion 120. In this state, the step of pressing the outer circumferential surface of the protrusion may be performed, thereby further enhancing the bonding force between the protrusion and the electrode terminal due to the adhesive properties of the sealing member 140.

Recently, there has been a demand for higher capacity while using a coin-type battery of the same size. A general secondary battery accommodates an electrode assembly in a case, couples a cap assembly to an opening of the case, and then welds the cap assembly to the case to seal the case. As the thickness of the cap assembly is reduced to achieve the higher capacity, there is a growing need to ensure the bonding strength between the electrode terminal of the cap assembly and the cap plate.

According to various embodiments of the present disclosure, the electrode terminal may be inserted into the protrusion extending downwardly from the through-hole of the base portion to seal the opening of the case, thereby enhancing the bonding strength of the electrode terminal.

According to various embodiments of the present disclosure, the sealing member can fully cover the region around the through-hole adjacent to the electrode terminal. This configuration allows the sealing member to effectively prevent short circuits between the base portion and the electrode terminal. Further, a secondary battery that includes such a configuration can reduce the risk of short circuits and improve safety.

According to various embodiments of the present disclosure, the configurations of the locking groove and locking protrusion formed in the protrusion and the electrode terminal with the sealing member in between to correspond to each other or the configurations of the threaded groove and thread formed in the protrusion and the electrode terminal with the sealing member in between to correspond to each other, can enhance the bonding strength of the electrode terminal.

According to various embodiments of the present disclosure, enhancing the bonding strength among the components of the cap assembly allows for a reduction in the thickness of the cap assembly. This can improve the capacity of the secondary battery and provide additional electrolyte space, thereby enhancing electrolyte retention.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

### EXPLANATION OF REFERENCE SYMBOLS

100: cap assembly
110: base portion
111: through-hole
120: protrusion
121: threaded groove
122: threaded groove
130: electrode terminal
131: locking protrusion
132: thread
133: stepped portion
140: sealing member
200: case
300: electrode assembly

What is claimed is:

1. A cap assembly, comprising:
a base portion having a through-hole;
a protrusion joined to the base portion, the protrusion extending downward from a lower end of the through-hole;
an electrode terminal at least partially inserted into the protrusion, the electrode terminal sealing the through-hole; and
a sealing member between the protrusion and the electrode terminal.

2. The cap assembly as claimed in claim 1, wherein a length of the protrusion is less than a length of the electrode terminal and a length of the sealing member.

3. The cap assembly as claimed in claim 1, wherein:
the protrusion comprises at least one locking groove recessed outwardly from an inner circumferential surface of the protrusion, and
the electrode terminal comprises at least one locking protrusion protruding from an outer circumferential surface of the electrode terminal in correspondence with a shape of the locking groove.

4. The cap assembly as claimed in claim 3, wherein the at least one locking protrusion is press-fitted into the at least one locking groove with the sealing member therebetween.

5. The cap assembly as claimed in claim 1, wherein the sealing member is a polymer-based adhesive comprising at least one of maleic anhydride grafted polypropylene and polypropylene.

6. The cap assembly as claimed in claim 1, wherein the sealing member extends outward from the through-hole to cover an upper surface of the base portion.

7. The cap assembly as claimed in claim 1, wherein:
the protrusion comprises a threaded groove recessed outwardly from an inner circumferential surface of the protrusion, the threaded groove extending along a longitudinal direction of the protrusion, and
the electrode terminal comprises a thread protruding outwardly from an outer circumferential surface of the electrode terminal, the electrode terminal extending along a longitudinal direction thereof, the thread having a shape corresponding to a shape of the threaded groove.

8. The cap assembly as claimed in claim 7, wherein the thread is engaged with the threaded groove and the sealing member is between the electrode terminal and the protrusion.

9. The cap assembly as claimed in claim 1, wherein the electrode terminal further comprises a stepped portion at an upper end thereof.

10. The cap assembly as claimed in claim 9, wherein:
the protrusion comprises at least one locking groove recessed outwardly from an inner circumferential surface of the protrusion, and
the electrode terminal comprises at least one locking protrusion protruding from an outer circumferential surface of the electrode terminal in correspondence with a shape of the locking groove.

11. The cap assembly as claimed in claim 9, wherein:
the protrusion comprises a threaded groove recessed outwardly from an inner circumferential surface of the protrusion, the protrusion extending along a longitudinal direction thereof, and
the electrode terminal comprises a thread protruding outwardly from an outer circumferential surface of the electrode terminal, the electrode terminal extending along a longitudinal direction thereof, the thread having a shape corresponding to a shape of the threaded groove.

12. A secondary battery, comprising:
an electrode assembly comprising a first electrode, a separator, and a second electrode;
a case having one open side, the case accommodating the electrode assembly through the open side; and
a cap assembly coupled to the open side of the case, wherein the cap assembly comprises:
a base portion having a through-hole;
a protrusion joined to the base portion, the protrusion extending downward from a lower end of the through-hole;
an electrode terminal at least partially inserted into the protrusion, the electrode terminal sealing the through-hole; and
a sealing member between the protrusion and the electrode terminal.

13. A method for manufacturing a cap assembly, the method comprising:
forming a through-hole in a base portion;
joining a protrusion extending downward from a lower end of the through-hole, to the base portion;
disposing a sealing member on an inner circumferential surface of the protrusion and an upper surface of the base portion; and
sealing the through-hole by inserting an electrode terminal at least partially into the protrusion in which the sealing member is surrounded by the protrusion.

14. The method as claimed in claim 13, further comprising pressing an outer circumferential surface of the protrusion after sealing the through-hole.

15. The method as claimed in claim 13, wherein, in joining the protrusion to the base portion, the protrusion has a length less than a length of the electrode terminal and a length of the sealing member.

16. The method as claimed in claim 13, wherein, in sealing the through-hole, the electrode terminal is secured to the protrusion by pressing a locking protrusion at the electrode terminal into a locking groove at the protrusion, the sealing member positioned between the electrode terminal and the protrusion.

17. The method as claimed in claim 13, wherein sealing the through-hole comprises engaging a thread at the electrode terminal with a threaded groove at the protrusion with the sealing member positioned between the electrode terminal and the protrusion.

18. The method as claimed in claim 13, wherein disposing the sealing member includes forming the sealing member of a polymer-based adhesive comprising at least one of maleic anhydride grafted polypropylene and polypropylene.

19. The method as claimed in claim 13, wherein sealing the through-hole comprises press-fitting the electrode terminal into the protrusion while compressing the sealing member.

20. The method as claimed in claim 13, wherein sealing the through-hole may further include forming a stepped portion in the electrode terminal at an upper end thereof.
